(19) United States
(12) Patent Application Publication
(10) Pub. No.: US 2020/0008586 A1
(43) Pub. Date: Jan. 9, 2020

(54) SEAT ASSEMBLY OF A CHILD HIGH CHAIR FOR DINING OR A GROCERY CART THAT PROVIDES A SEAT FOR A SMALL CHILD

(71) Applicants: Punam Singh, Alpharetta, GA (US); Sanjeev Kumar Singh, Alpharetta, GA (US)

(72) Inventors: Punam Singh, Alpharetta, GA (US); Sanjeev Kumar Singh, Alpharetta, GA (US)

(21) Appl. No.: 16/026,142

(22) Filed: Jul. 3, 2018

(51) Int. Cl. A47D 15/00; A47D 1/00; B62B 5/08

(52) U.S. Cl. CPC A47D 15/006; B62B 5/082; A47D 1/00

(57) ABSTRACT

A seat assembly of a high chair or a grocery cart is provided. The seat assembly comprises a seating base, a seating back, a rod and a hollow tube. The seating base has a front end and a back end along a length of the seating base and a first side end and a second side end along a width of the seating base. The seating back is located at the back end of the seating base and angled substantially transverse to the seating base. The rod is disposed on the front end of the seating base and along the width of the seating base at a distance above the seating base and in-between the first side end and the second side end of the seating base. The hollow tube has a top surface. The hollow tube is disposed surrounding the rod.

### BACKGROUND

### 1. Field

Aspects of the present invention relates stacking high chair seating and grocery cart seating such as a seat assembly of a child high chair for dining or a grocery cart that provides a seat for a small child.

### 2. Description of the Related Art

High chair is a chair usually for feeding older babies and younger toddlers. The high chair is raised to a certain height from the ground, so that the overall height with child seating thereon is close to that of an adult. Hence, an adult may feed the child conveniently.

A typical grocery cart has a main basket for placing groceries therein as well as it provides a seat for a small child or a place to rest objects, which folds out along a side closest to where the handle is located. The seat can fold out and provide a place for holding personal items, such as a handbag or purse, or to support a small child, as in the intended use. When the seat is not being used, the frame can fold up and rearwards to lay flat against a rear wall of the shopping cart.

However, in a high chair seat or a grocery cart seat sometimes it is difficult to place a child in position as the design of the seating space is odd and difficult to navigate when laying legs of the child in leg openings of the high chair or the grocery cart. One has to angle the two legs to pass through tight space into the leg openings. Sometimes this act is tricky and painful for the child if legs and not properly aligned with the leg openings and don't go in smoothly.

Therefore, more suitable means for providing easy seating in a seat assembly of a high chair or a grocery cart are needed.

### SUMMARY

Briefly described, aspects of the present invention relate to a seat assembly of a child high chair for dining or a grocery cart that provides a seat for a small child. The seat assembly provides a suitable means for easy seating in the seat assembly of a high chair or a grocery cart. The seat assembly properly aligns two legs of a child with leg openings of a high chair or a grocery cart. The seat assembly assists with travel of the legs in the leg openings as a hollow tube rotates over a rod above and in front of a seat when the hollow tube touches the legs being inserted into the leg openings. The hollow tube is rotationally disposed on the rod.

In accordance with one illustrative embodiment of the present invention, a seat assembly of a high chair or a grocery cart is provided. The seat assembly comprises a seating base, a seating back, a rod and a hollow tube. The seating base has a front end and a back end along a length of the seating base and a first side end and a second side end along a width of the seating base. The seating back is located at the back end of the seating base and angled substantially transverse to the seating base. The rod is disposed on the front end of the seating base and along the width of the seating base at a distance above the seating base and in-between the first side end and the second side end of the seating base. The hollow tube has a top surface. The hollow tube is disposed surrounding the rod.

Consistent with yet another embodiment, a high chair comprises a seat frame having first and second legs and a seat assembly coupled to the seat frame on a top end. The seat assembly includes a seating base having a front end and a back end along a length of the seating base and a first side end and a second side end along a width of the seating base. The seat assembly further includes a seating back located at the back end of the seating base and angled substantially transverse to the seating base. The seat assembly further includes a rod disposed on the front end of the seating base and along the width of the seating base at a distance above the seating base and in-between the first side end and the second side end of the seating base. The seat assembly further includes a hollow tube having a top surface. The hollow tube is disposed surrounding the rod such that the hollow tube is configured free to move or rotate over the rod in response to a frictional force applied to the top surface of the hollow tube.

According to yet one another embodiment, a grocery cart comprises a basket with a plurality of wheels and a seat assembly coupled to the basket on a back edge. The seat assembly includes a seating base having a front end and a back end along a length of the seating base and a first side end and a second side end along a width of the seating base. The seat assembly further includes a seating back located at the back end of the seating base and angled substantially transverse to the seating base. The seat assembly further includes a rod disposed on the front end of the seating base and along the width of the seating base at a distance above the seating base and in-between the first side end and the second side end of the seating base. The seat assembly further includes a hollow tube having a top surface. The hollow tube is disposed surrounding the rod such that the hollow tube is configured free to move or rotate over the rod in response to a frictional force applied to the top surface of the hollow tube.

### BRIEF DESCRIPTION OF THE DRAWINGS

FIG. 1 illustrates a perspective view depicting an illustrative child high chair for dining with a seat assembly capable of assisting sliding of legs of a child in a seat location in accordance with an exemplary embodiment of the present invention.

FIG. 2 illustrates a cross-sectional view of a rod and a hollow tube mounted on the rod with a bearing in-between in accordance with an exemplary embodiment of the present invention.

FIG. 3 illustrates a perspective view depicting an illustrative child high chair for dining with a seat assembly having two separate leg openings in accordance with an exemplary embodiment of the present invention.

FIG. 4 depicts a perspective view depicting an illustrative grocery cart including a seat with a seat assembly for a small child in accordance with an exemplary embodiment of the present invention.

FIG. 5 depicts a partial view of a grocery cart including a seat with a seat assembly for a small child in accordance with an exemplary embodiment of the present invention.

### DETAILED DESCRIPTION

To facilitate an understanding of embodiments, principles, and features of the present invention, they are explained hereinafter with reference to implementation in illustrative embodiments. In particular, they are described in the context of providing easy seating in a seat assembly of a high chair or a grocery cart. The seat assembly is capable of assisting sliding of legs of a child in a seat location. In this way, it is not difficult to place a child in position as a structure of a seating space is not odd and difficult to navigate when resting legs of the child in leg openings of the high chair or the grocery cart. Embodiments of the present invention, however, are not limited to use in the described devices or methods.

The components and materials described hereinafter as making up the various embodiments are intended to be illustrative and not restrictive. Many suitable components and materials that would perform the same or a similar function as the materials described herein are intended to be embraced within the scope of embodiments of the present invention.

Although some embodiments of this invention may be described and illustrated herein in terms of high chair and grocery cart, it should be understood that embodiments of this invention are not so limited but are generally applicable to seat assemblies. Further, although some embodiments of this invention may be described and illustrated herein in the context of a rod and a hollow pipe, it should be understood that embodiments of this invention are not so limited but are generally applicable to any type of seat assembly formats and combinations.

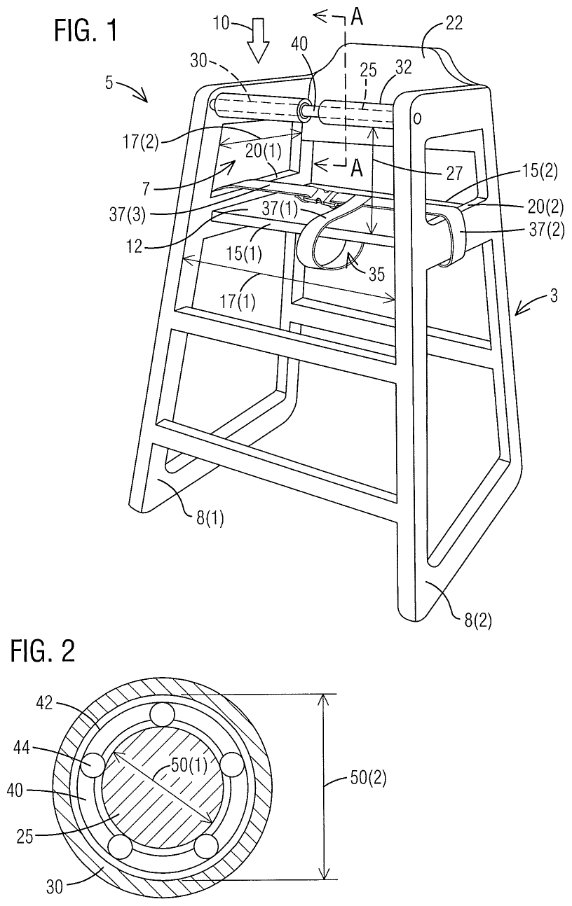

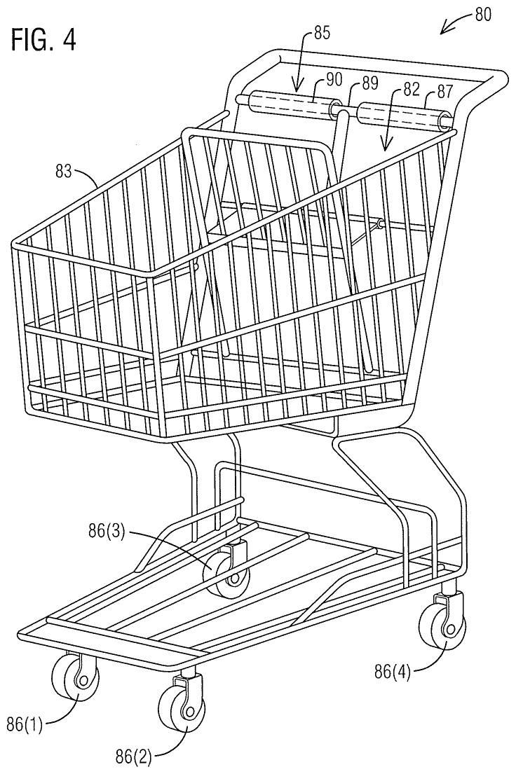

Consistent with one embodiment of the present invention, FIG. 1 illustrates a perspective view depicting an illustrative child high chair 5 for dining with a seat assembly 7 capable of assisting sliding of legs of a child in a seat location 10 in accordance with an exemplary embodiment of the present invention. The seat assembly 7 may be of a high chair or a grocery cart. The seat assembly 7 provides a suitable means for easy seating in the seat assembly 7 of the high chair 5 or a grocery cart (see FIG. 4).

The high chair 5 comprises a seat frame 3 having first and second legs 8(1-2). The seat assembly 7 is coupled to the seat frame 3 on a top end.

The seat assembly 7 is configured to properly align two legs of a child with leg openings of the high chair 5 or a grocery cart. The seat assembly 7 is configured to providing easy seating in the high chair 5 or a grocery cart. The seat assembly 7 is capable of assisting sliding of legs of a child in a seat location.

In this way, it is not difficult to place a child in position as a structure of the seat assembly 7 is not odd and difficult to navigate when resting legs of the child in leg openings of the high chair 5 or the grocery cart. For example, the seat assembly 7 may be integrated into a stacking high chair seating or a grocery cart seating. That is, the seat assembly 7 may be built-in a child high chair for dining or a grocery cart that provides a seat for a small child.

Here the seat assembly 7 comprises a seating base 12 having a front end 15(1) and a back end 15(2) along a length 17(1) of the seating base 12 and a first side end 20(1) and a second side end 20(2) along a width 17(2) of the seating base 12. The seat assembly 7 further comprises a seating back 22 located at the back end 15(2) of the seating base 12 and angled substantially transverse to the seating base 12. The seat assembly 7 further comprises a rod 25 disposed on the front end 15(1) of the seating base 12 and along the width 17(2) of the seating base 12 at a distance 27 above the seating base 12 and in-between the first side end 20(1) and the second side end 20(2) of the seating base 12.

The seat assembly 7 further comprises a hollow tube 30 having a top surface 32. The hollow tube 30 is disposed surrounding the rod 25. The rod 25 comprises at least one of a wood, a plastic or a metal and the hollow tube 30 comprises at least one of a wood, a plastic or a metal. The hollow tube 30 is configured free to move or rotate over the rod 25 in response to a frictional force applied to the top surface 32 of the hollow tube 30. The seat assembly 7 is configured to assist with travel of the legs in the leg openings as the hollow tube 30 rotates over the rod 25 above and in front of a seat when the hollow tube 30 touches the legs being inserted into the leg openings. The hollow tube 30 is rotationally disposed on the rod 25.

The seat assembly 7 further comprises a seat belt 35 including first, second and third harnesses 37(1-3) each of which having a connector (not visible) or a loop (not visible) on a distal end. The seat assembly 7 further comprises a bearing 40 to facilitate rotation of the hollow tube 30 on the rod 25.

Referring to FIG. 2, it illustrates a cross-sectional view of the rod 25 and the hollow tube 30 mounted on the rod with the bearing 40 in-between in accordance with an exemplary embodiment of the present invention. The bearing 40 comprises metal components including a casing 42 and balls 44. For example, the bearing 40 may comprise stainless steel. The rod 25 may have a first diameter 50(1) and the hollow tube 30 may have a second diameter 50(2) such that the first diameter 50(1) is smaller than the second diameter 50(2).

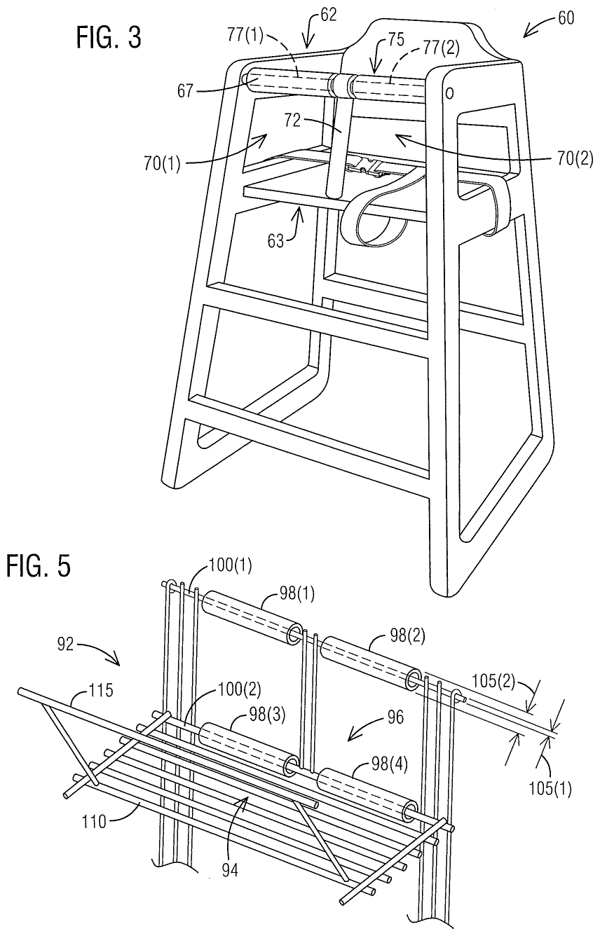

Turning now to FIG. 3, it illustrates a perspective view depicting an illustrative child high chair 60 for dining with a seat assembly 62 having two separate leg openings in accordance with an exemplary embodiment of the present invention. In the seat assembly 62, a space 63 underneath a rod 67 is divided in two portions such that a perpendicular rod 72 through the space 63 defines a first leg opening 70(1) and a second leg opening 70(2). The seat assembly 62 comprise a hollow tube 75 including a first tube 77(1) and a second tube 77(2) laterally separated from the first tube 77(1) on the rod 67.

FIG. 4 depicts a perspective view depicting an illustrative grocery cart 80 including a seat 82 with a seat assembly 85 for a small child in accordance with an exemplary embodiment of the present invention. The grocery cart 80 comprises a basket 83 with a plurality of wheels 86(1-4) and the seat assembly 85 coupled to the basket 83 on a back edge.

The seat assembly 85 further comprises a hollow tube 87 having a top surface 89. The hollow tube 87 is disposed surrounding a rod 90. The hollow tube 87 is rotationally disposed on the rod 90. The rod 90 comprises at least one of a wood, a plastic or a metal and the hollow tube 87 comprises at least one of a wood, a plastic or a metal.

The hollow tube 87 is configured free to move or rotate over the rod 90 in response to a frictional force applied to the top surface 89 of the hollow tube 87. The seat assembly 85 is configured to assist with travel of the legs in the leg openings as the hollow tube 87 rotates over the rod 90 above and in front of a seat when the hollow tube 87 touches the legs being inserted into the leg openings.

As seen in FIG. 5, it depicts a partial view of a grocery cart 92 including a seat 94 with a seat assembly 96 for a small child in accordance with an exemplary embodiment of the present invention. The seat assembly 96 further comprises a plurality of hollow tubes 98(1-4) surrounding a first rod 100(1) and a second rod 100(2) two each. The first rod 100(1) and the second rod 100(2) comprises at least one of a wood, a plastic or a metal and the plurality of hollow tubes 98(1-4) comprises at least one of a wood, a plastic or a metal.

The first rod 100(1) and the second rod 100(2) may have a first diameter 105(1) and the plurality of hollow tubes 98(1-4) may have a second diameter 105(2) such that the first diameter 105(1) is smaller than the second diameter 105(2). The seat assembly 96 further comprises a bearing (not shown, but similar to the bearing 40 in FIG. 2) to facilitate rotation of the plurality of hollow tubes 98(1-4) on the first rod 100(1) and the second rod 100(2).

The seat assembly 96 includes a seating base 110 having a front end and a back end along a length of the seating base 110 and a first side end and a second side end along a width of the seating base 110. The seat assembly 96 further includes a seating back 115 located at the back end of the seating base 110 and angled substantially transverse to the seating base 110.

While a high chair or a grocery cart in a seating configuration is described here a range of other constructions of seating arrangements are also contemplated by the present invention. For example, other types of seating formations may be implemented based on one or more features presented above without deviating from the spirit of the present invention.

The techniques described herein can be particularly useful for an integrated seat with a seat assembly that defines a seating space or a location or a spot disposed in a high chair or a grocery cart. While particular embodiments are described in terms of such an integrated seating configuration, the techniques described herein are not limited to this but can also be used with other suitable layouts.

While embodiments of the present invention have been disclosed in exemplary forms, it will be apparent to those skilled in the art that many modifications, additions, and deletions can be made therein without departing from the spirit and scope of the invention and its equivalents, as set forth in the following claims.

Embodiments and the various features and advantageous details thereof are explained more fully with reference to the non-limiting embodiments that are illustrated in the accompanying drawings and detailed in the following description. Descriptions of well-known starting materials, processing techniques, components and equipment are omitted so as not to unnecessarily obscure embodiments in detail. It should be understood, however, that the detailed description and the specific examples, while indicating preferred embodiments, are given by way of illustration only and not by way of limitation. Various substitutions, modifications, additions and/or rearrangements within the spirit and/or scope of the underlying inventive concept will become apparent to those skilled in the art from this disclosure.

As used herein, the terms “comprises,” “comprising,” “includes,” “including,” “has,” “having” or any other variation thereof, are intended to cover a non-exclusive inclusion. For example, a process, article, or apparatus that comprises a list of elements is not necessarily limited to only those elements but may include other elements not expressly listed or inherent to such process, article, or apparatus.

Additionally, any examples or illustrations given herein are not to be regarded in any way as restrictions on, limits to, or express definitions of, any term or terms with which they are utilized. Instead, these examples or illustrations are to be regarded as being described with respect to one particular embodiment and as illustrative only. Those of ordinary skill in the art will appreciate that any term or terms with which these examples or illustrations are utilized will encompass other embodiments which may or may not be given therewith or elsewhere in the specification and all such embodiments are intended to be included within the scope of that term or terms.

In the foregoing specification, the invention has been described with reference to specific embodiments. However, one of ordinary skill in the art appreciates that various modifications and changes can be made without departing from the scope of the invention. Accordingly, the specification and figures are to be regarded in an illustrative rather than a restrictive sense, and all such modifications are intended to be included within the scope of invention.

Although the invention has been described with respect to specific embodiments thereof, these embodiments are merely illustrative, and not restrictive of the invention. The description herein of illustrated embodiments of the invention is not intended to be exhaustive or to limit the invention to the precise forms disclosed herein (and in particular, the inclusion of any particular embodiment, feature or function is not intended to limit the scope of the invention to such embodiment, feature or function). Rather, the description is intended to describe illustrative embodiments, features and functions in order to provide a person of ordinary skill in the art context to understand the invention without limiting the invention to any particularly described embodiment, feature or function. While specific embodiments of, and examples for, the invention are described herein for illustrative purposes only, various equivalent modifications are possible within the spirit and scope of the invention, as those skilled in the relevant art will recognize and appreciate. As indicated, these modifications may be made to the invention in light of the foregoing description of illustrated embodiments of the invention and are to be included within the spirit and scope of the invention. Thus, while the invention has been described herein with reference to particular embodiments thereof, a latitude of modification, various changes and substitutions are intended in the foregoing disclosures, and it will be appreciated that in some instances some features of embodiments of the invention will be employed without a corresponding use of other features without departing from the scope and spirit of the invention as set forth. Therefore, many modifications may be made to adapt a particular situation or material to the essential scope and spirit of the invention.

Respective appearances of the phrases “in one embodiment,” “in an embodiment,” or “in a specific embodiment” or similar terminology in various places throughout this specification are not necessarily referring to the same embodiment. Furthermore, the particular features, structures, or characteristics of any particular embodiment may be combined in any suitable manner with one or more other embodiments. It is to be understood that other variations and modifications of the embodiments described and illustrated herein are possible in light of the teachings herein and are to be considered as part of the spirit and scope of the invention.

In the description herein, numerous specific details are provided, such as examples of components and/or methods, to provide a thorough understanding of embodiments of the invention. One skilled in the relevant art will recognize, however, that an embodiment may be able to be practiced without one or more of the specific details, or with other apparatus, systems, assemblies, methods, components, materials, parts, and/or the like. In other instances, well-known structures, components, systems, materials, or operations are not specifically shown or described in detail to avoid obscuring aspects of embodiments of the invention. While the invention may be illustrated by using a particular embodiment, this is not and does not limit the invention to any particular embodiment and a person of ordinary skill in the art will recognize that additional embodiments are readily understandable and are a part of this invention.

Although the steps, operations, or computations may be presented in a specific order, this order may be changed in different embodiments. In some embodiments, to the extent multiple steps are shown as sequential in this specification, some combination of such steps in alternative embodiments may be performed at the same time.

Embodiments described herein can be implemented in the form of control logic in software or hardware or a combination of both. The control logic may be stored in an information storage medium, such as a computer-readable medium, as a plurality of instructions adapted to direct an information processing device to perform a set of steps disclosed in the various embodiments. Based on the disclosure and teachings provided herein, a person of ordinary skill in the art will appreciate other ways and/or methods to implement the invention.

It will also be appreciated that one or more of the elements depicted in the drawings/figures can also be implemented in a more separated or integrated manner, or even removed or rendered as inoperable in certain cases, as is useful in accordance with a particular application.

Benefits, other advantages, and solutions to problems have been described above with regard to specific embodiments. However, the benefits, advantages, solutions to problems, and any component(s) that may cause any benefit, advantage, or solution to occur or become more pronounced are not to be construed as a critical, required, or essential feature or component.

1. A seat assembly of a high chair or a grocery cart, the seat assembly comprising:
a seating base having a front end and a back end along a length of the seating base and a first side end and a second side end along a width of the seating base;
a seating back located at the back end of the seating base and angled substantially transverse to the seating base;
a rod disposed along the width of the seating base at a distance above the seating base and in-between the first side end and the second side end of the seating base; and
a hollow tube having a top surface, the hollow tube is disposed surrounding the rod such that the hollow tube is configured free to move or rotate over the rod in response to a frictional force applied to the top surface of the hollow tube,
wherein the hollow tube is mounted in a fixed position relative to the rod such that the hollow tube is not removable and does not have a cut-out or a longitudinal slit or a longitudinal slot.

2. The seat assembly of claim 1, wherein a space underneath the rod is divided in two portions such that a perpendicular rod through the space defines a first leg opening and a second leg opening.

3. The seat assembly of claim 1, wherein the hollow tube comprises a first tube and a second tube laterally separated from the first tube on the rod.

4. The seat assembly of claim 1, wherein the rod having a first diameter and the hollow tube having a second diameter such that the first diameter is smaller than the second diameter.

5. The seat assembly of claim 1, further comprising:
a seat belt including first, second and third harnesses each of which having a connector or a loop on a distal end.

6. The seat assembly of claim 1, wherein the rod comprises at least one of a wood, a plastic or a metal and the hollow tube comprises at least one of a wood, a plastic or a metal.

7. (canceled)

8. The seat assembly of claim 1, further comprising:
a bearing to facilitate rotation of the hollow tube on the rod.

9. The seat assembly of claim 8, wherein the bearing comprises metal components including a casing and balls.

10. A high chair comprising:
a seat frame having first and second legs;
a seat assembly coupled to the seat frame on a top end, the seat assembly including:
a seating base having a front end and a back end along a length of the seating base and a first side end and a second side end along a width of the seating base;
a seating back located at the back end of the seating base and angled substantially transverse to the seating base;
a rod disposed along the width of the seating base at a distance above the seating base and in-between the first side end and the second side end of the seating base; and
a hollow tube having a top surface, the hollow tube is disposed surrounding the rod such that the hollow tube is configured free to move or rotate over the rod in response to a frictional force applied to the top surface of the hollow tube,
wherein the hollow tube is mounted in a fixed position relative to the rod such that the hollow tube is not removable and does not have a cut-out or a longitudinal slit or a longitudinal slot.

11. The high chair of claim 10, wherein a space underneath the rod is divided in two portions such that a perpendicular rod through the space defines a first leg opening and a second leg opening.

12. The high chair of claim 10, wherein the hollow tube comprises a first tube and a second tube laterally separated from the first tube on the rod.

13. The high chair of claim 10, wherein the rod having a first diameter and the hollow tube having a second diameter such that the first diameter is smaller than the second diameter and wherein the rod comprises at least one of a wood, a plastic or a metal and the hollow tube comprises at least one of a wood, a plastic or a metal.

14. The high chair of claim 10, further comprising:
a seat belt including first, second and third harnesses each of which having a connector or a loop on a distal end.

15. The high chair of claim 1, further comprising:
a bearing to facilitate rotation of the hollow tube on the rod, wherein the bearing comprises metal components including a casing and balls.

16. A grocery cart comprising:
a basket with a plurality of wheels;
a seat assembly coupled to the basket on a back edge, the seat assembly including:
a seating base having a front end and a back end along a length of the seating base and a first side end and a second side end along a width of the seating base;
a seating back located at the back end of the seating base and angled substantially transverse to the seating base;
a rod disposed along the width of the seating base at a distance above the seating base and in-between the first side end and the second side end of the seating base; and
a hollow tube having a top surface, the hollow tube is disposed surrounding the rod such that the hollow tube is configured free to move or rotate over the rod in response to a frictional force applied to the top surface of the hollow tube,
wherein the hollow tube is mounted in a fixed position relative to the rod such that the hollow tube is not removable and does not have a cut-out or a longitudinal slit or a longitudinal slot.

17. The grocery cart of claim 16, wherein a space underneath the rod is divided in two portions such that a perpendicular rod through the space defines a first leg opening and a second leg opening.

18. The grocery cart of claim 16, wherein the hollow tube comprises a first tube and a second tube laterally separated from the first tube on the rod.

19. The grocery cart of claim 16, wherein the rod having a first diameter and the hollow tube having a second diameter such that the first diameter is smaller than the second diameter and wherein the rod comprises at least one of a wood, a plastic or a metal and the hollow tube comprises at least one of a wood, a plastic or a metal.

20. The grocery cart of claim 16, further comprising:
a seat belt including first, second and third harnesses each of which having a connector or a loop on a distal end; and
a bearing to facilitate rotation of the hollow tube on the rod, wherein the bearing comprises metal components including a casing and balls.
